(19) United States
(12) Patent Application Publication
(10) Pub. No.: US 2021/0200808 A1
(43) Pub. Date: Jul. 1, 2021

(54) PRISON MONITORING INTELLIGENT CONTROL METHOD WITH COMPARATIVE ANALYSIS FUNCTION

(71) Applicant: HEFEI COMPASS ELECTRONIC TECHNOLOGY CO., LTD., Anhui (CN)

(72) Inventors: Ye SHI, Anhui (CN); Liankun DANG, Anhui (CN)

(73) Assignee: HEFEI COMPASS ELECTRONIC TECHNOLOGY CO., LTD., Anhui (CN)

(21) Appl. No.: 16/307,484

(22) PCT Filed: Oct. 31, 2018
(86) PCT No.: PCT/CN2018/112949

§ 371 Date: Dec. 6, 2018

(30) Foreign Application Priority Data
Sep. 21, 2018 (CN) 201811109325.8

(51) Int. Cl. G06F 16/9035; G06F 16/9038; G06F 16/903

(52) U.S. Cl. CPC G06F 16/9035; G06F 16/90335; G06F 16/9038

(57) ABSTRACT

The present application discloses a prison monitoring intelligent control method with comparative analysis function, establish a identifier-age-type model based on the correspondence between each imprisonment identifier and the age and crime type of the corresponding imprisoned person, and store the identifier-age-type model, determine the abnormal level of the two imprisoned persons based on the total duration of the meeting, querying the age and/or crime type corresponding to the two imprisoned persons in the identifier-age-type model, according to the abnormality level; formulating an early warning strategy based on the analysis results of the age and/or crime type of the two imprisoned persons and feedback. The present application pre-judges the behavioral dynamics of the any two imprisoned persons by analyzing the relationship between the total meeting duration, age and crime type of the two prisoners in the prison, effectively preventing the imprisoned persons from the occurrence of abnormal situations such as collusion of the imprisoned persons, comprehensively and effectively protecting security in the prison.

This application claims priority to Chinese Patent Application No. 201811109325.8, filed to the Chinese Patent Office on Sep. 21, 2018, entitled “Prison monitoring intelligent control method with comparative analysis function”, the entire disclosure of which is incorporated herein by reference.

### BACKGROUND

### Technical Field

The present application relates to the technical field of monitoring control methods, and in particular to prison monitoring intelligent control method with comparative analysis function.

### Background Art

There are some high-risk prisoners held in prisons, who are more likely to flee, self-mutilate or party troubles. Therefore, it is necessary to conduct more strict management and comprehensive monitoring of high-risk prisoners, understand their behavior and prevent the occurrence of violence, to safeguard the personal safety of supervisors and the incarcerated persons. High-risk prisoners are usually monitored through monitoring device such as cameras. However, monitoring device such as cameras is relatively limited, because impossibility to monitor every prisoner or every area, which brings certain difficulties to prison supervision. And the simple monitoring system can only monitor the active position of the imprisoned persons, but the behavioral dynamics of the imprisoned persons cannot be pre-judged. When there are abnormal situations such as collusion of the imprisoned persons, the existing monitoring system is difficult to guarantee security inside the prison.

### SUMMARY OF THE INVENTION

Based on the technical problems existing in the background art, the present application proposes prison monitoring intelligent control method with comparative analysis function.

The prison monitoring intelligent control method with comparative analysis function proposed in the present application comprises the following steps:

S1. assigning an imprisonment identifier to each imprisoned person in the prison, and establish an identifier-age-type model based on the correspondence between each imprisonment identifier and the age and crime type of the corresponding imprisoned person, and store the identifier-age-type model;

S2. Counting the total duration of the meeting of any two imprisoned persons in the prison within a preset time period, and determine the abnormal level of the two imprisoned persons based on the total duration of the meeting;

S3. Querying the age and/or crime type corresponding to the two imprisoned persons in the identifier-age-type model, according to the abnormality level;

S4. formulating an early warning strategy based on the analysis results of the age and/or crime type of the two imprisoned persons, and feedback the above-mentioned early warning strategy and the imprisonment identifiers of the two imprisoned persons to the supervision department.

Preferably, in S2, there is a preset duration;

In S2, the total length of the meeting time accumulated by any two imprisoned persons in the prison within a preset time period specifically comprises:

obtaining a single meeting duration of any two imprisoned persons in the prison;

comparing the single meeting duration with a preset duration, and marking the meeting as a valid meeting when the single meeting duration is longer than a preset duration;

marking the duration of the meeting of the above valid meeting as the calculation term of the total meeting duration of the two imprisoned persons.

Preferably, in S2, there are a first total duration C₁, a second total duration C₂, and a third total duration C₃;

In S2, determining an abnormality level of the two imprisoned persons based on the total meeting duration specifically comprises:

obtaining the total meeting duration of any two imprisoned persons in the prison in the preset time period, which recorded as C;

comparing the total face length C respectively with the first total duration C₁, the second total duration C₂, and the third total duration C₃:

when C>C₁, determining the two imprisoned persons be the first abnormal level;

when C>C₂, determining the two imprisoned persons be the second abnormal level;

when C>C₃, determining the two imprisoned persons be the third abnormal level; wherein, C₁<C₂<C₃.

Preferably, S3 specifically comprises:

obtaining the abnormal level of the two imprisoned persons;

obtaining the ages of the two imprisoned persons when the two imprisoned persons are the first abnormal level;

obtaining the type of crime of the two imprisoned persons when the two imprisoned persons are the second abnormal level;

obtaining the ages and crime types of the two imprisoned persons when the two imprisoned persons are in the third abnormal level.

Preferably, in S4, there is a preset age difference;

S4 specifically comprises:

obtaining the age and/or type of crime of the two imprisoned persons;

calculating the actual age difference between the two imprisoned persons and marking the crime types of the two imprisoned persons as the first type of crime and the second type of crime;

comparing the actual age difference between the two imprisoned persons and the preset age difference, and the first crime type and the second crime type respectively:

formulating a first early warning strategy, when the actual age difference between the two imprisoned persons is greater than the preset age difference;

formulating a second early warning strategy, when the first crime type is different from the second crime type;

formulating a third early warning strategy, when the actual age difference between the two imprisoned persons is greater than the preset age difference and the first crime type is different from the second crime type;

wherein the first early warning strategy is to mark the information that the total meeting duration of the two imprisoned persons with a long time and a large age difference;

the second early warning strategy is to mark the information that the total meeting duration of the two imprisoned persons with a long time and different crime types;

the third early warning strategy is to mark the information that the information that the total meeting duration of the two imprisoned persons with a long time, large age different, and different crime types.

Preferably, S4 further comprises:

selecting different early warning means based on different early warning strategies;

selecting a first early warning means when the intelligent control module formulates the first early warning strategy;

selecting a second early warning means when the intelligent control module formulates the second early warning strategy;

selecting a third early warning means when the intelligent control module formulates the third early warning strategy;

wherein the first early warning means is to keep the frequency of feeding back information to the supervision department as P₁;

the second early warning means is to keep the frequency of feedback to the supervision department as P₂;

the third early warning means is to keep the frequency of feeding back information to the supervision department as P₃;

wherein, P₁, P₂, and P₃ are preset values, P₁<P₃, and P₂<P₃.

Preferably, in the identifier-age-type model in S 1, one imprisonment identifier, one age, and one crime type are one-to-one correspondence.

Preferably, in S1, when an imprisoned person has at least two types of crimes, the most recent type of crime is selected as the type of crime corresponding to the imprisonment identifier of the imprisoned person.

The prison monitoring intelligent control method with comparative analysis function proposed in the present application, first establishes the correspondence between the age, the type of crime and the identity of each imprisoned person in the prison, and facilitates to analyze in the subsequent process that whether the age and type of crime of each imprisoned person have an impact on their own abnormal conditions, providing a direct and effective reference basis for the analysis process; then, by analyzing the total meeting duration of any two imprisoned persons in the prison during the preset time period, determines the abnormal level of the two imprisoned persons, so as to qualitative analyze whether the two imprisoned persons with potential risk, and which is conducive to improve the fineness of the analysis; analyzes the age and/or crime type of the two imprisoned persons according to the different abnormal levels mentioned above, and the targeted selection of the analysis object is beneficial to further improve the effectiveness of the analysis process; finally, formulates different early warning strategies according to the analysis of age and/or crime types of the two imprisoned persons.

On the one hand, the supervision department can understand the actual situation of the two incarcerated persons in real time, which helps the supervision department to analyze the potential danger between the two, and on the other hand, it provides direct and effective analytical data of supervision of the prisoners in the prison for supervision department, to improve the management efficiency of the supervision department and optimize the environment within the prison.

The present application pre-judges the behavioral dynamics of the any two imprisoned persons by analyzing the relationship between the total meeting duration, age and crime type of the two prisoners in the prison, effectively preventing the imprisoned persons from the occurrence of abnormal situations such as collusion of the imprisoned persons, comprehensively and effectively protecting security in the prison.

### BRIEF DESCRIPTION OF DRAWING

FIG. 1 is a schematic flow chart of a prison monitoring intelligent control method with comparative analysis function according to the present application.

### DETAILED DESCRIPTION OF THE EMBODIMENTS

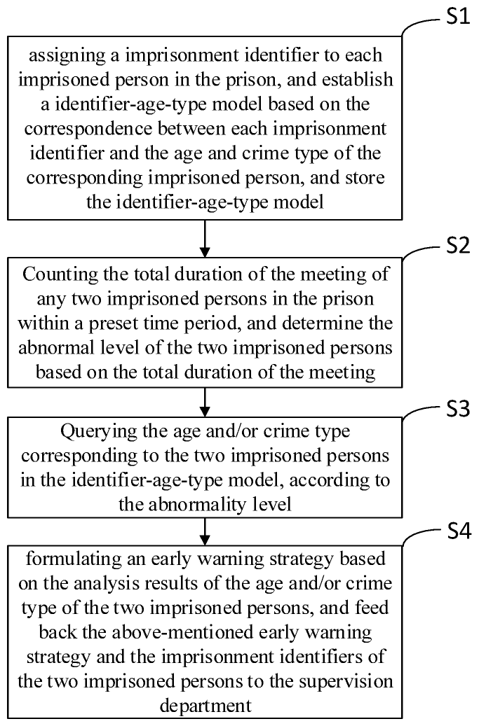

As shown in FIG. 1, FIG. 1 is a schematic flow chart of a prison monitoring intelligent control method with comparative analysis function according to the present application.

Refer to FIG. 1, the prison monitoring intelligent control method with comparative analysis function proposed in the present application comprises the following steps:

S1. assigning an imprisonment identifier to each imprisoned person in the prison, and establish an identifier-age-type model based on the correspondence between each imprisonment identifier and the age and crime type of the corresponding imprisoned person, and store the identifier-age-type model;

In the present embodiment, in the identifier-age-type model, one imprisonment identifier, one age, and one crime type are one-to-one correspondence.

Further, when an imprisoned person has at least two types of crimes, the most recent type of crime is selected as the type of crime corresponding to the imprisonment identifier of the imprisoned person.

S2. Counting the total duration of the meeting of any two imprisoned persons in the prison within a preset time period, and determine the abnormal level of the two imprisoned persons based on the total duration of the meeting;

In the present embodiment, in S2, there is a preset duration;

In S2, the total length of the meeting time accumulated by any two imprisoned persons in the prison within a preset time period specifically comprises:

obtaining a single meeting duration of any two imprisoned persons in the prison;

comparing the single meeting duration with a preset duration, and marking the meeting as a valid meeting when the single meeting duration is longer than a preset duration;

marking the duration of the meeting of the above valid meeting as the calculation term of the total meeting duration of the two imprisoned persons.

In S2, there are a first total duration C₁, a second total duration C₂, and a third total duration C₃;

In S2, determining an abnormality level of the two imprisoned persons based on the total meeting duration specifically comprises:

obtaining the total meeting duration of any two imprisoned persons in the prison in the preset time period, which recorded as C;

comparing the total face length C respectively with the first total duration C₁, the second total duration C₂, and the third total duration C₃:

when C>C₁, it indicates that the total duration of the meeting of the two imprisoned persons accumulated in the preset time period reaches the first level, then determining the two imprisoned persons be the first abnormal level;

when C>C₂, it indicates that the total duration of the meeting of the two imprisoned persons accumulated in the preset time period reaches the second level, then determining the two imprisoned persons be the second abnormal level;

when C>C₃, it indicates that the total duration of the meeting of the two imprisoned persons accumulated in the preset time period reaches the third level, then determining the two imprisoned persons be the third abnormal level;

wherein, C₁<C₂<C.

S3. Querying the age and/or crime type corresponding to the two imprisoned persons in the identifier-age-type model, according to the abnormality level;

In the present embodiment, S3 specifically comprises:

obtaining the abnormal level of the two imprisoned persons;

obtaining the ages of the two imprisoned persons when the two imprisoned persons are the first abnormal level;

obtaining the type of crime of the two imprisoned persons when the two imprisoned persons are the second abnormal level;

obtaining the ages and crime types of the two imprisoned persons when the two imprisoned persons are in the third abnormal level.

According to the different abnormal levels of the two imprisoned persons, different parameters are selected as the analysis object, which is beneficial to improve the pertinence of the analysis process on one hand, and able to ensure the validity and accuracy of the analysis results on the other hand.

S4. Formulating an early warning strategy based on the analysis results of the age and/or crime type of the two imprisoned persons, and feedback the above-mentioned early warning strategy and the imprisonment identifiers of the two imprisoned persons to the supervision department.

In the present embodiment, in S4, there is a preset age difference;

S4 specifically comprises:

obtaining the age and/or type of crime of the two imprisoned persons;

calculating the actual age difference between the two imprisoned persons and marking the crime types of the two imprisoned persons as the first type of crime and the second type of crime;

comparing the actual age difference between the two imprisoned persons and the preset age difference, and the first crime type and the second crime type respectively:

when the actual age difference between the two imprisoned persons is greater than the preset age difference, it shows that the actual ages of the two imprisoned persons are quite different, and in such situation, it is not normal for the two imprisoned persons to meet each other for a long time, then formulating a first early warning strategy in order to make the supervision department know the above abnormal situation in time; the first early warning strategy is to mark the information that the total meeting duration of the two imprisoned persons with a long time and a large age difference;

when the first crime type is different from the second crime type, it shows that the two types of imprisoned persons have different types of crimes, and in such situation, it is not normal for the two imprisoned persons to meet each other for a long time, then formulating a second early warning strategy in order to make the supervision department know the above abnormal situation in time; the second early warning strategy is to mark the information that the total meeting duration of the two imprisoned persons with a long time and different crime types;

when the actual age difference between the two imprisoned persons is greater than the preset age difference and the first crime type is different from the second crime type, it shows that the actual ages of the two imprisoned persons are different, and the crime types of the two imprisoned persons are different, in such situation, it is not normal for the two imprisoned persons to meet each other for a long time, then formulating a third early warning strategy in order to make the supervision department know the above abnormal situation in time; the third early warning strategy is to mark the information that the information that the total meeting duration of the two imprisoned persons with a long time, large age different, and different crime types.

In a further embodiment, S4 further comprises:

selecting different early warning means based on different early warning strategies;

selecting a first early warning means when the intelligent control module formulates the first early warning strategy;

selecting a second early warning means when the intelligent control module formulates the second early warning strategy;

selecting a third early warning means when the intelligent control module formulates the third early warning strategy;

wherein the first early warning means is to keep the frequency of feeding back information to the supervision department as P₁;

the second early warning means is to keep the frequency of feedback to the supervision department as P₂;

the third early warning means is to keep the frequency of feeding back information to the supervision department as P₃;

wherein, P₁, P₂, and P₃ are preset values, P₁<P₃, and P₂<P₃.

Selecting different information feedback frequencies is conducive to reflecting the urgency of abnormal situations through the frequency, so that the supervision department can take timely targeted treatment measures and plans according to actual conditions and actual needs, and comprehensively ensure the safety in the prison.

The prison monitoring intelligent control method with comparative analysis function proposed in the present application, first establishes the correspondence between the age, the type of crime and the identity of each imprisoned person in the prison, and facilitates to analyze in the subsequent process that whether the age and type of crime of each imprisoned person have an impact on their own abnormal conditions, providing a direct and effective reference basis for the analysis process; then, by analyzing the total meeting duration of any two imprisoned persons in the prison during the preset time period, determines the abnormal level of the two imprisoned persons, so as to qualitative analyze whether the two imprisoned persons with potential risk, and which is conducive to improve the fineness of the analysis; analyzes the age and/or crime type of the two imprisoned persons according to the different abnormal levels mentioned above, and the targeted selection of the analysis object is beneficial to further improve the effectiveness of the analysis process; finally, formulates different early warning strategies according to the analysis of age and/or crime types of the two imprisoned persons.

On the one hand, the supervision department can understand the actual situation of the two incarcerated persons in real time, which helps the supervision department to analyze the potential danger between the two, and on the other hand, it provides direct and effective analytical data of supervision of the prisoners in the prison for supervision department, to improve the management efficiency of the supervision department and optimize the environment within the prison.

The present embodiment pre-judges the behavioral dynamics of the any two imprisoned persons by analyzing the relationship between the total meeting duration, age and crime type of the two prisoners in the prison, effectively preventing the imprisoned persons from the occurrence of abnormal situations such as collusion of the imprisoned persons, comprehensively and effectively protecting security in the prison.

The above is only the preferred embodiment of the present application, but the scope of protection of the present application is not limited thereto, and any equivalents or modifications of the technical solutions of the present application and the application concept thereof should be included in the scope of the present application within the scope of the technical scope of the present application.

1. A Prison monitoring intelligent control method with comparative analysis function, comprising the following steps:
S1: assigning an imprisonment identifier to each imprisoned person in the prison, and establish an identifier-age-type model based on a correspondence between each imprisonment identifier and the age and crime type of the corresponding imprisoned person, and store the identifier-age-type model;
S2: counting a total meeting duration of any two imprisoned persons in the prison within a preset time period, and determine an abnormal level of the two imprisoned persons based on the total meeting duration;
S3: querying the age and/or crime type corresponding to the two imprisoned persons in the identifier-age-type model, according to the abnormal level;
S4: formulating an early warning strategy based on the analysis results of the age and/or crime type of the two imprisoned persons, and feedback the early warning strategy and the imprisonment identifiers of the two imprisoned persons to a supervision department.

2. The prison monitoring intelligent control method with comparative analysis function according to claim 1, wherein in step S2, there is a preset duration;
in step S2, the total meeting duration accumulated by any two imprisoned persons in the prison within the preset time period specifically comprises:
obtaining a single meeting duration of any two imprisoned persons in the prison;
comparing the single meeting duration with the preset duration, and marking the meeting as a valid meeting when the single meeting duration is longer than the preset duration;
marking the duration of the meeting of the valid meeting as a calculation term of the total meeting duration of the two imprisoned persons.

3. The prison monitoring intelligent control method with comparative analysis function according to claim 1, wherein in step S2, there are a first total duration C₁, a second total duration C₂, and a third total duration C₃;
in step S2, determining the abnormal level of the two imprisoned persons based on the total meeting duration specifically comprises:
obtaining the total meeting duration of any two imprisoned persons in the prison in the preset time period, which recorded as C;
comparing the total meeting duration C respectively with the first total duration C₁, the second total duration C₂, and the third total duration C₃:
when C>C₁, determining the two imprisoned persons be a first abnormal level;
when C>C₂, determining the two imprisoned persons be a second abnormal level;
when C>C₃, determining the two imprisoned persons be a third abnormal level;
wherein, C₁<C₂<C₃.

4. The prison monitoring intelligent control method with comparative analysis function according to claim 3, wherein step S3 specifically comprises:
obtaining the abnormal level of the two imprisoned persons;
obtaining the ages of the two imprisoned persons when the two imprisoned persons are the first abnormal level;
obtaining the type of crime of the two imprisoned persons when the two imprisoned persons are the second abnormal level;
obtaining the ages and crime types of the two imprisoned persons when the two imprisoned persons are in the third abnormal level.

5. The prison monitoring intelligent control method with comparative analysis function according to claim 4, wherein in step S4, there is a preset age difference;
S4 specifically comprises:
obtaining the age and/or type of crime of the two imprisoned persons;
calculating the actual age difference between the two imprisoned persons and marking the crime types of the two imprisoned persons as the first type of crime and the second type of crime;
comparing the actual age difference between the two imprisoned persons and the preset age difference, and the first crime type and the second crime type respectively:
formulating a first early warning strategy, when the actual age difference between the two imprisoned persons is greater than the preset age difference;
formulating a second early warning strategy, when the first crime type is different from the second crime type;
formulating a third early warning strategy, when the actual age difference between the two imprisoned persons is greater than the preset age difference and the first crime type is different from the second crime type;
wherein the first early warning strategy is to mark the information that the total meeting duration of the two imprisoned persons with a long time and a large age difference;
the second early warning strategy is to mark the information that the total meeting duration of the two imprisoned persons with a long time and different crime types;
the third early warning strategy is to mark the information that the information that the total meeting duration of the two imprisoned persons with a long time, large age different, and different crime types.

6. The prison monitoring intelligent control method with comparative analysis function according to claim 5, wherein step S4 further comprises:
selecting different early warning means based on different early warning strategies;
selecting a first early warning means when the intelligent control module formulates the first early warning strategy;
selecting a second early warning means when the intelligent control module formulates the second early warning strategy;
selecting a third early warning means when the intelligent control module formulates the third early warning strategy;
wherein the first early warning means is to keep the frequency of feeding back information to the supervision department as P₁;
the second early warning means is to keep the frequency of feedback to the supervision department as P₂;
the third early warning means is to keep the frequency of feeding back information to the supervision department as P₃;
wherein, P₁, P₂, and P₃ are preset values, P₁<P₃, and P₂<P₃.

7. The prison monitoring intelligent control method with comparative analysis function according to claim 1, wherein in the identifier-age-type model in step S1, one imprisonment identifier, one age, and one crime type are one-to-one correspondence.

8. The prison monitoring intelligent control method with comparative analysis function according to claim 1, wherein in step S1, when the imprisoned person has at least two types of crimes, the most recent type of crime is selected as the type of crime corresponding to the imprisonment identifier of the imprisoned person.
